(19) United States
(12) Patent Application Publication
(10) Pub. No.: US 2003/0004699 A1
(43) Pub. Date: Jan. 2, 2003

(54) Method and apparatus for evaluating an integrated circuit model

(76) Inventors: Charles Y. Choi, San Francisco, CA (US); Jeffrey A. Ebert, Half Moon Bay, CA (US); Adam Levinthal, Redwood City, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/163,192

(22) Filed: Jun. 4, 2002

Related U.S. Application Data
(60) Provisional application No. 60/296,068, filed on Jun. 4, 2001.

(51) Int. Cl. G06F 17/50

(52) U.S. Cl. 703/14

(57) ABSTRACT

A system and method that enables a user to design and use an Integrated Circuit (IC) simulation model without having access to confidential information contained within the model. In one embodiment the system includes a secure section where confidential simulation model information is contained and accessed. The user does not have access to this secure section. The user is provided access to the system via a user-interaction section, which provides controlled access to the IC model. The user can then establish and initiate simulations of the IC model, selecting test stimulus associated with the cores used within the IC model.

This application claims the benefit of U.S. Provisional Application No. 60/296,068, filed Jun. 4, 2001.

### FIELD OF THE INVENTION

The present invention relates to testing and evaluating the combination of components within an integrated circuit system model.

### BACKGROUND

Electronic computing and communications systems continue to include greater numbers of features and to increase in complexity. At the same time, electronic computing and communications systems decrease in physical size and cost per function. Rapid advances in semiconductor technology such as four-layer deep-sub-micron complimentary metal-oxide semiconductor (CMOS) technology have enabled true integrated circuit (IC) designs, also considered “system-on-a-chip” (SOC) designs. These complex designs may incorporate, for example, one or more processor components, a digital signal processing (DSP) component, memory, several communications interfaces, and a graphics support component.

It is more efficient and practical for most IC designers to incorporate components already developed rather than redesigning all the necessary hardware with each new IC design. Often the components within an IC model involve intellectual property (IP) owned by groups other than the creators of the IC model.

Hardware description language, or HDL, code can be used to represent the function of components used in IC design. Two examples of a simulation model representation are Verilog and VHDL. The simulation model of a component enables a detailed and in-depth understanding of how that component operates and interacts with other components. It will be apparent to those of ordinary skill in the art that any manner of representing an IC design or a simulation model of an IC design using an HDL representation or other symbolic representation is considered within the scope of the present invention.

One of the problems with IC design is that in order for an IC designer to know whether one component will work with another component in order to achieve the designer's needs, the IC design simulation model must be available for the given component. Because the simulation model provides such valuable insight into the operation and capability of components, those who own the IP for the components do not disclose the simulation model without carefully drafted legal agreements between the two parties. Negotiating such agreements takes time and costs money for all parties. If a designer wants to test out a design or idea, then procuring such agreements is a significant detriment to rapid, efficient and cost-effective design development.

### SUMMARY OF THE INVENTION

A system and method that enables a user to design and use an Integrated Circuit (IC) simulation model without having access to confidential simulation information contained within the model is disclosed. In one embodiment the system includes a secure section where confidential simulation model information is contained and accessed. The user does not have access to this secure section. The user is provided access to the system via a user-interaction section, which provides controlled access to the IC model. The user can then establish and initiate simulations of the IC model, selecting test stimulus associated with the cores used within the IC model.

A core is an electronic design implementable in hardware and typically represented in a hardware description language (HDL). An IC model is a set of interconnected cores, sometimes referred to herein as intellectual property (IP) cores, IP blocks, blocks, or components. The IC model as a whole is typically specified in a top-level netlist, also typically represented using HDL.

### BRIEF DESCRIPTION OF THE DRAWINGS

The objects, features and advantages of the present invention will be apparent from the following detailed description in which:

FIG. 1 is a block diagram of one embodiment of the present invention.

FIG. 2 is a more detailed block diagram illustrating an embodiment of the present invention.

FIG. 3 is a flow diagram illustrating one embodiment of the process of the present invention.

FIG. 4 is a flow diagram illustrating an embodiment of the process of the present invention.

FIGS. 5, 6, 7 and 8 illustrate exemplary screen displays of a graphical user interface (GUI) in accordance with one embodiment of the present invention.

FIG. 9 illustrates the testbench of one embodiment of the present invention.

### DETAILED DESCRIPTION

The method and system of the present invention enables a designer to design and use a simulation model in a minimum amount of time without the need to access confidential information contained within the model to determine if the operation of the core and components of the simulation model satisfy the designer's needs. This is achieved in part by avoiding legal negotiation of agreements between a designer (or company) and the owner of the Intellectual Property (IP) to be embodied in the simulation model. In one embodiment, the method and system of the present invention shields disclosure of the proprietary portions of the simulation model, core and/or components to an external designer while giving the designer an understanding about whether or not the components, core or model meet design goals.

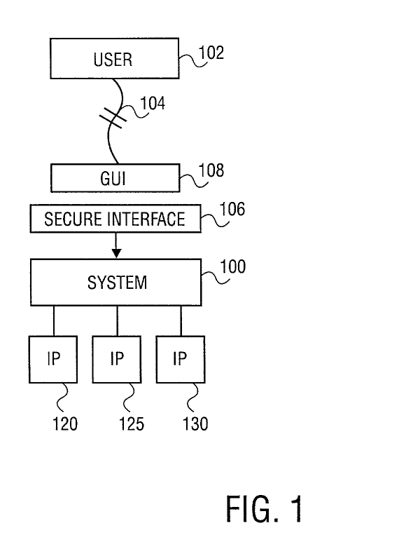

FIG. 1 is a block diagram of one embodiment of the present invention. System 100 couples to user 102 through network 104. One example of network 104 is the Internet, though any coupling, for example dedicated, distributed, local, wired, wireless, optical or otherwise, between user 102 and secure interface 106 can fulfill the role of network 104. User 102 connects to network 104 through any well-known medium, for example a personal computer or a workstation with suitable interface software.

In the present embodiment, user 102 connects to system 100 for the purpose of evaluating a simulation model. It is apparent that the present invention is not limited to particular models and is applicable to any multi-element or multi-component integrated circuit system. Furthermore, for purposes of discussion herein, the term “model” will be used to refer to models as well as systems and components.

In one embodiment, the user 102 utilizes a user interface, such as a graphical user interface (GUI), whereby the user 102 selects from various test stimuli associated with semiconductor cores, or components, to design an IC model that meets the design requirements of the user 102. It should be noted that the user interface is not limited to a GUI but can be any interface that enables the user to send information and receive information from system 100. Examples of components include processors, memory, and communication ports, but may further include any portion of a system design, such as an IC model design. In one embodiment, the user 102 selects from a list or presentation of available components and designs a custom IC model. In another embodiment, the user 102 selects from a predesigned IC model available on system 100 for a particular purpose, for example a small office/home office router. In still another embodiment, the user 102 may select components and further provide information regarding other components, for example components of the user, to design a custom IC model.

Each component (for example, a processor or memory) 120, 125, 130 presented to the user through the GUI 108 has corresponding hardware description language (HDL) code that corresponds to the function and response of the particular component. The simulation model is not viewable or accessible by user 102, as the user 102 cannot access the simulation model through the secure interface 106. One advantage of using a simulation model is that there is a greater degree of certainty that the software model created with the code can be implemented in actual hardware. The code may be implemented as conventional Verilog or VHDL, though any HDL or other simulation model representation may be used. HDL code is well known in the art and not further discussed herein.

In one embodiment, the IP of the component or a model provider includes the simulation model of the components/model and in some instances the test stimulus for exercising the simulation model. For purposes of simplifying the discussion below, reference will simply be made to the simulation model whenever possible. The operator of system 100 therefore pre-negotiates legal obligations concerning the simulation model of the components/model, for example licensing, use, or non-disclosure agreements, and has access to the appropriate simulation model 120, 125, 130 corresponding to each component/model accessible by the user. The intellectual property rights may be owned, for example, by a third party that developed the component and corresponding simulation model and test stimulus. The legal obligations function to protect the rights, including the intellectual property (IP) rights of the third party. As noted above, in the present embodiment, the user 102 is prevented from accessing the simulation model, therefore protecting the underlying rights of the third party.

In one embodiment, model components and associated test stimuli are available for selection by a user via GUI 108. Once user 102 indicates the component(s) in a design, or picks a pre-designed IC model, through GUI 108, the user 102 selects from available tests in order to simulate the operation and/or behavior of the design. For example, system 100 prepares a simulation of an IC model based on the simulation model associated with each of the components and the appropriate input and output signals of the components. The system can then run user selected, system selected and/or user provided tests on the simulation. For example, the user may select certain tests to run using certain signal inputs and/or signal or system constructs. In another embodiment, the user 102 provides tests to system 100 which are used as a test stimulus for the simulation of the IC model. Thus, tests with respect to a particular design including a particular set of components may, in one embodiment, be pre-established and stored for easy access when needed. Alternately, the tests for different combinations of components or models may be developed at a time of specification by the user. Further, tests for sub-groupings of components may be pre-specified or later specified and applied for simulation of the model.

System 100 couples to network 104 through secure interface 106. Secure interface 106 enables the user 102 to access the GUI 108 and prevents user 102 from accessing confidential information of third party providers of IP. Examples of a secure interface 106 include a conventional firewall incorporated into a computer system router as well as software within a computer (not shown) designed to limit and control access to files.

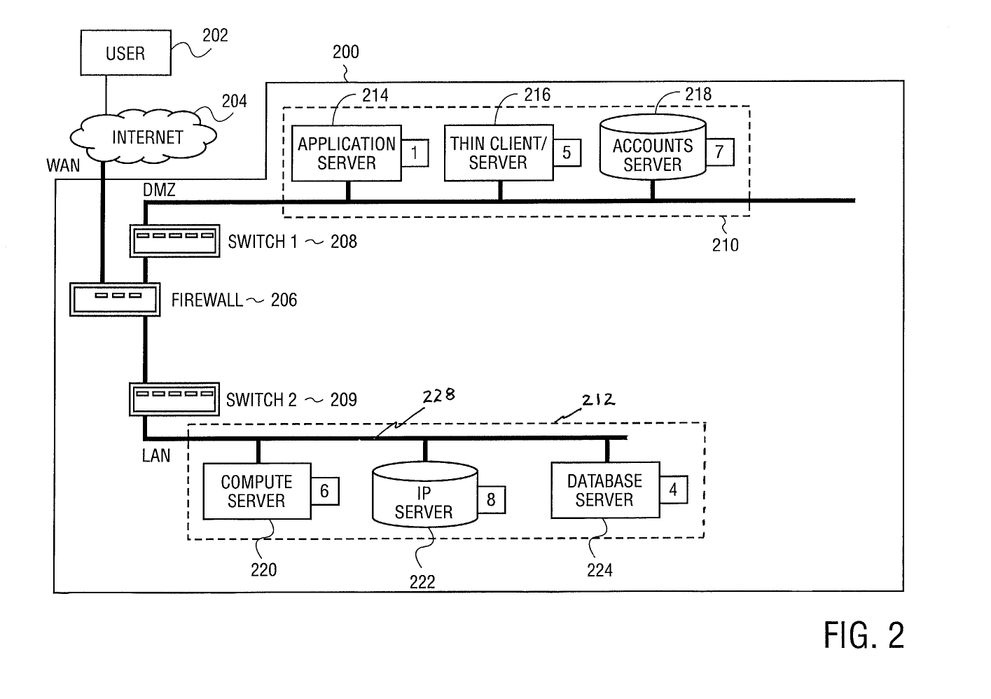

The system 100 may be implemented a variety of ways. For example, the system may be implemented on a personal computer, workstation and the like. Alternately, the system 100 may be implemented using a variety of interconnected components such as the system illustrated in FIG. 2.

In the embodiment illustrated by FIG. 2, user 202 communicates with the system 200 via a network or other connection 204, such as the Internet through a secure interface, in the present embodiment, firewall 206.

One example by which a firewall 206 couples to a network is through an Ethernet connection. A firewall can provide network address translation (NAT), Domain Name Server (DNS) and Internet protocol (IP) filtering services for system 200, known in the art and used for communications between the user 202 and system 200.

In the embodiment of the system of the present invention illustrated by FIG. 2, firewall 206 couples to switches 208, 209. Switches 208, 209 operate in conjunction with the firewall 206 to direct traffic within system 200. In one embodiment, switch 208 controls access to user-interaction subsystem 210 (i.e. user-interaction section) and switch 209 controls access to computation subsystem 212 (i.e. secure section).

User interaction subsystem 210 includes application server 214, thin client server 216, and user account server 218. In one embodiment, application server 214 provides basic user functions such as HTTP, electronic mail, and Virtual Network Computing (VNC) packet routing. Other embodiments including other applications may be implemented.

Thin client server 216 provides VNC services which provide screen emulation of a platform or operating system for a GUI, for example Unix. Thin client server 216 in conjunction with application server 214 allows a user 202 with a web browser, for example a Java-enabled web browser, to select and/or design an IC model and to see outputs and inputs of tests for simulation of IC models selected through a GUI generated by application server 214 and a web browser accessible by the user 202. Furthermore, in one embodiment, server 216 stores a shadow representation of the IP cores made available for selection by the user.

Account server 218 creates user accounts and stores IC designs and other information for user 202.

As noted above, user interaction subsystem 210 is located on the DMZ side of firewall 206 as shown in FIG. 2. Computation subsystem 212 (i.e. the secure section) is located on the secured side of the firewall 206 and therefore is protected from unauthorized access by the user. Computation subsystem 212 includes compute server 220, IP server 222, and database server 224.

Compute server 220 performs calculations necessary to enable simulation and/or testing of the simulation models. Thus, in one example, user 202 can select the tests to run on the IC model, which was also user selected. In this manner, the user can provide selected input data for simulation and view the output data of the tests without accessing or viewing confidential information having proprietary IP rights attached to the simulation model and its components. Only the compute server 220, located on the secured side of the system, can access the real (not the shadow representation) IC model or IP cores. In one embodiment, thin client server 216, utilizing a network of interconnected components, directs compute server 220 to construct a list of tests based on tests available from IP server 222.

IP server 222 accesses simulation model representative of each component and/or model selectable by a user 202 to construct a composite IC model. In one example, third party vendors, who own the IP rights attached to the respective components, provide the proprietary simulation model stored on IP server 222. Because this code is in the secure section, the code remains inaccessible to a user, except for selection as part of a simulation. In another example, a secure offsite location coupled to network 228 maintains the necessary proprietary simulation model. The simulation model, in one embodiment, also includes code necessary to test the component. This is typically provided by third party vendors, although it may also be provided by the provider of the computation subsystem 212.

Database server 224 stores and provides access to user registration information. In one embodiment database server 224 responds to a structured query language (SQL), a standard interactive and programming language for getting information from and updating the database. However, a variety of types of databases and languages may be used.

Once the user is authorized to enter the system, the user can work on an IC model of interest. In one embodiment, the user accesses a pre-designed IC model for further testing. In another embodiment, the user accesses a standard configuration and combination of components on which to base a particular design of interest to the user. In still another embodiment, the user may establish an original design of a combination of components available. Alternately, the user may provide one or more components of the design to operate in conjunction with other components of third parties. In each case, the user can create a desired IC model without access to proprietary component or test code.

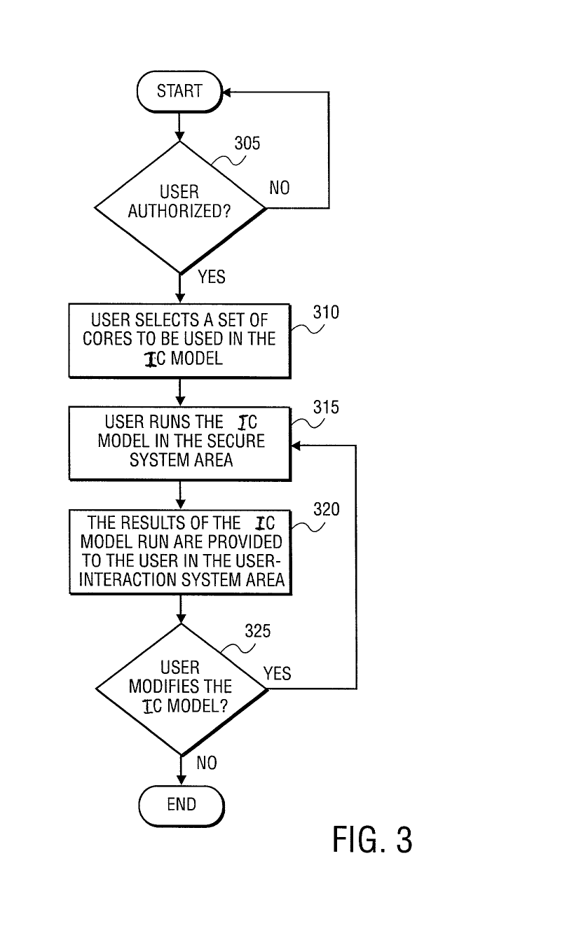

FIG. 3 is a simplified flow diagram illustrating one embodiment of the process of the present invention. At step 305, it is determined whether the user is authorized to access the system. This step, in one embodiment, also functions to provide the user with other data and information relevant to earlier work performed by the user through this system. At step 310, the user selects a set of cores to be used in the IC model. As noted above, the user may select from a pre-designed IC model or the user may design an IC model by selecting components from a portfolio of existing components (i.e. cores). Alternately, the user may be able to design custom components. In each case, the user cannot access the confidential internal structure of the selected components.

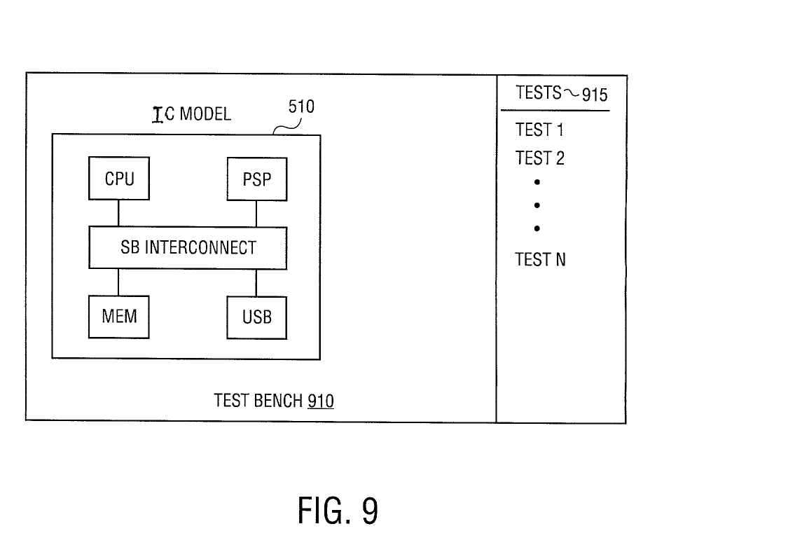

Using the IC model designed or selected, the user runs the IC model in the secure area of the system (step 315). In one embodiment, the user may run the IC model within a testbench, such as the one illustrated in FIG. 9. Testbench 910 is a structure that executes the IC model for the purpose of simulation. The testbench 910 typically includes a set of tests 915 from which a user may select a particular test for exercising the IC model. The testbench 910 is normally written in HDL. The user may also provide particular inputs to the tests to be performed. As noted earlier, the user has no access to the secure area and no access to the IP of the components, the testbench, and the tests of the IC model therein, thereby eliminating the need for the user to negotiate with each of the IP owner(s) for access to the IC model or component information for design development and design simulation.

At step 320, the results of the IC model run are provided to the user. The user is provided the results in the user-interaction system area on the DMZ side of the firewall. Thus, the component and IC model IP remains secure while the user gains the benefit of viewing results of a particular model simulation. Depending upon the simulation results, the user may wish to perform additional simulations, change the inputs to the tests, or even change the IC model/component configuration being simulated, step 325.

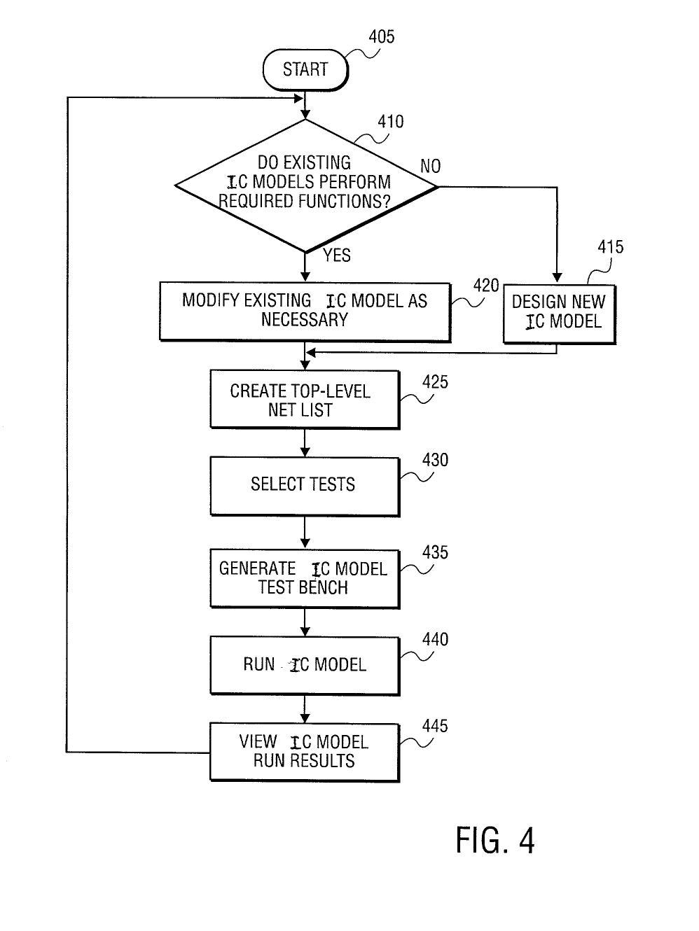

FIG. 4 is a flowchart showing steps for creating and evaluating an IC model. A user is initially authorized to access the system at step 405. Access may be attempted through a variety of media including wired, wireless connections, networks and the like. In one embodiment, the identity of the user is viewed prior to access, for example, by requesting a name and password. Name and password information with respect to the users, may be stored in the system, along with any previously designed IC models of the user. After verifying the identity of user and granting access, the application server in combination with the thin client server, in one embodiment, present the user with a GUI to manipulate. Using the GUI, the user can select further options. As noted earlier, the user can interface with the system using a variety of types of interfaces and is not limited to a GUI.

At step 410 the user, using the GUI, determines if any existing IC models perform the functions desired by the user. One example of a function is a router with firewall and print server capabilities.

If a user finds a model with a desired functionality, step 420, the model is utilized as is or modified as desired. For example, IP cores may be available for addition or substitution of existing cores within the pre-designed IC model. Furthermore, components may be removed from the selected IC model.

The user may also choose to design a new IC model, step 415. In one embodiment, in a drag and drop GUI, the user may select from a list of components and drag graphical representations of selected components into the graphical representation of the IC model.

At step 425, the user can then generate a top-level netlist of the IC model. In short, the top-level netlist is a description of how all IP cores within the IC model are connected to each other. This netlist provides the user information on the set of tests that can be run on the IC model. The user initiates the process to create the netlist on the thin client server 216 (see FIG. 2) and the actual creation of the netlist occurs on the compute server 220 (see FIG. 2).

At step 430, in one embodiment, the user selects tests to run on the simulation of the IC model. These tests may be provided by the IP core supplier, the implementer of the embodiment, or by the user. The set of available tests provided to the user is determined by the set of cores used in the IC model. The user can then select a subset of these tests to run on the IC model. The set of tests selected are stored on the thin client server 216.

At step 435, a testbench for the IC model is created. The testbench 910 (as shown in FIG. 9 and described above) provides the ability to run tests on the IC model. This testbench is typically written in a HDL such as Verilog. The set of tests previously selected by the user are passed to this testbench 910 for execution when the IC model is run. The creation of this testbench 910 is done on the Compute server 220 (see FIG. 2).

At step 440, the IC model is run using the generated testbench 910 and the user-selected tests and/or configuration data. An embodiment of this is to simulate the IC model using an HDL simulator. This activity is performed on the Compute server 220 (see FIG. 2).

At step 445, the output of the IC model run can then be viewed by the user. This output provides the user with information on the behavior of the IP cores within an IC model context. This information can help the user determine if the core suits their need. The output results are transferred from the compute server 220 to the thin client server 216 so that the user can view the results. A variety of views can be provided. One embodiment is to provide a waveform view of the signal activity for each interface of each core. Another is to provide a performance analysis of the activity occurring between the different cores.

It should be recognized that the design and test process may be repeatedly performed on a user modified IC model.

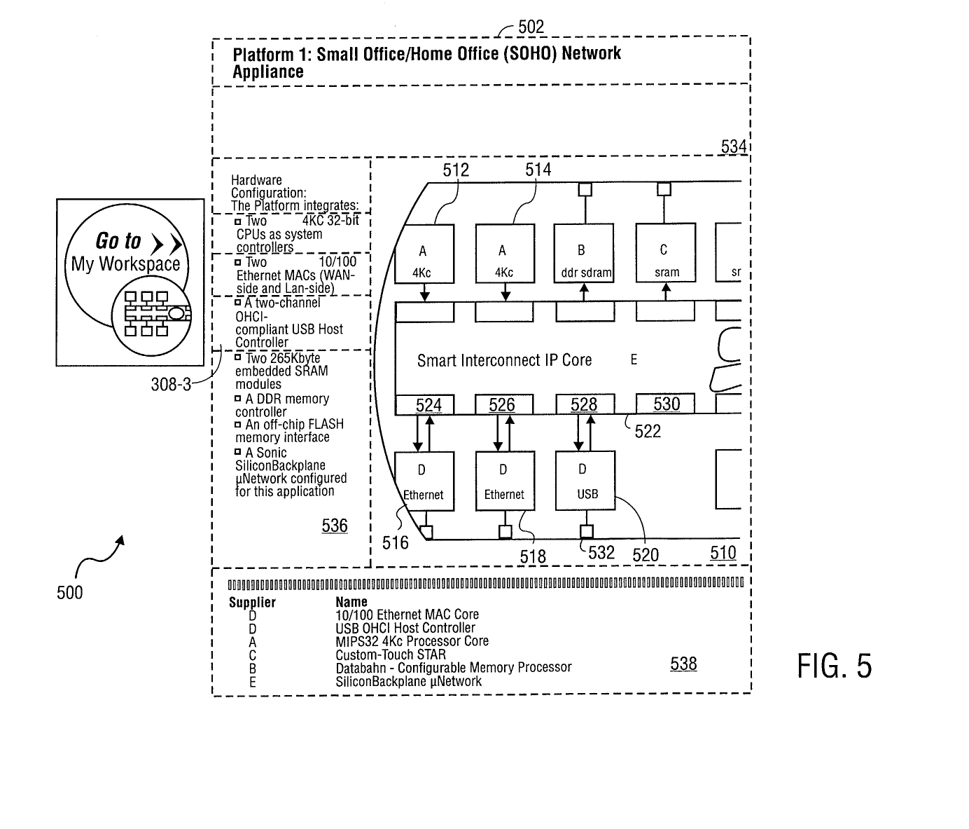

As noted above, in one embodiment, a graphical user interface (GUI) is utilized to communicate with the user. FIGS. 5-8 are illustrative of one example of screen displays of a GUI that operates in accordance with the teachings of the present invention. After the user gains access to the system, the user may be provided a display such as that illustrated in FIG. 5. Screen 500 is one example of a GUI offering a predesigned IC model. Model type 502 shows a small office/home office network appliance.

Graphical representation 510 is a graphical layout of the predesigned IC model. Components are graphically represented by simple graphic components, for example, CPUs 512, 514, Ethernet controllers 516, 518 and USB host controller 520. Graphical representation 510 shows components 512, 514, 516, 518 and 520 coupled to, for example, a graphical representation of a smart interconnect IP core 522 with interface ports 524, 526, 528 and 530. In another embodiment, components 512, 514, 516, 518 and 520 couple to a system bus (not shown). Graphical representation 510 also shows components coupling to physical leads on a chip, for example component 520 is coupled to lead 532.

The present embodiment also includes other information present throughout the GUI to assist the user in the design of a model. These include, but are not limited to, a description of the model function 534, a hardware description 536 and listing of component providers 538. Description 534 provides information on the purpose and function of the model. Hardware configuration 536 provides information on components, e.g. 512, 514, 516, 518 and 520 within the predesigned IC model. Components include, for example, CPUs, Ethernet controllers, USB host controller, SRAM modules, a DDR memory controller, FLASH memory interface and a network. A brief description accompanies each component identified. The different suppliers or component providers are identified in section 538.

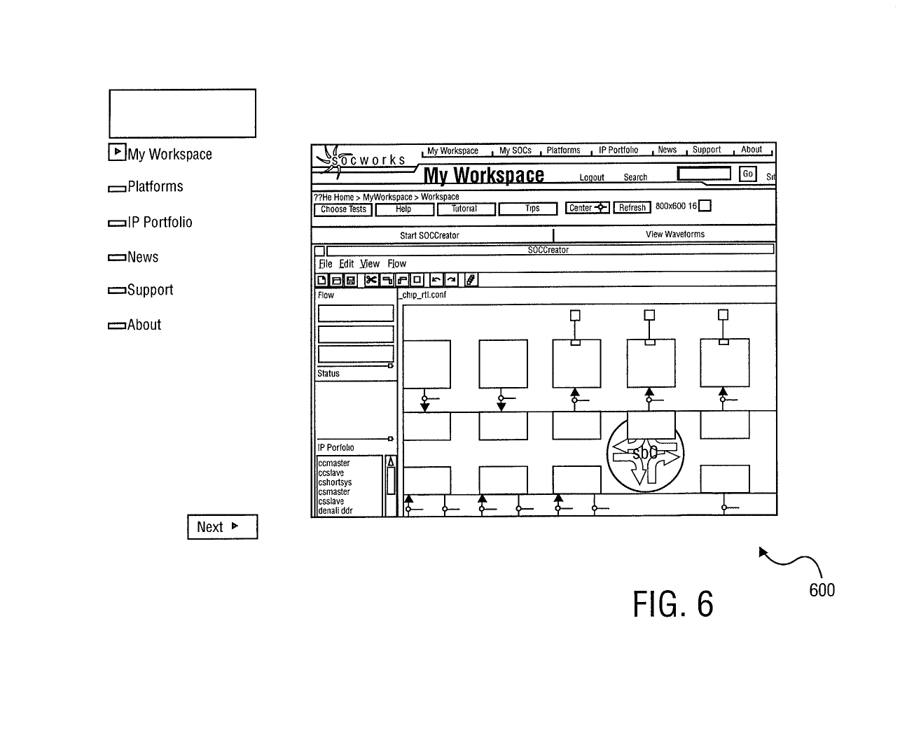

FIG. 6 shows one example of a GUI representing display of an authorized user's workspace. The workspace gives the user remote access to design tools, including simulation of and/or modification of an IC model. The display 600 can be configured as an interactive drag-and-drop GUI in which the user changes the configuration of an IC model graphically by movement of displayed components, whether predesigned or designed by the user. The user selects components and manipulates, e.g. adds, removes or replaces them with a tool, for example, a mouse, track ball, touch screen or the like, or adds components to the IC model in the display.

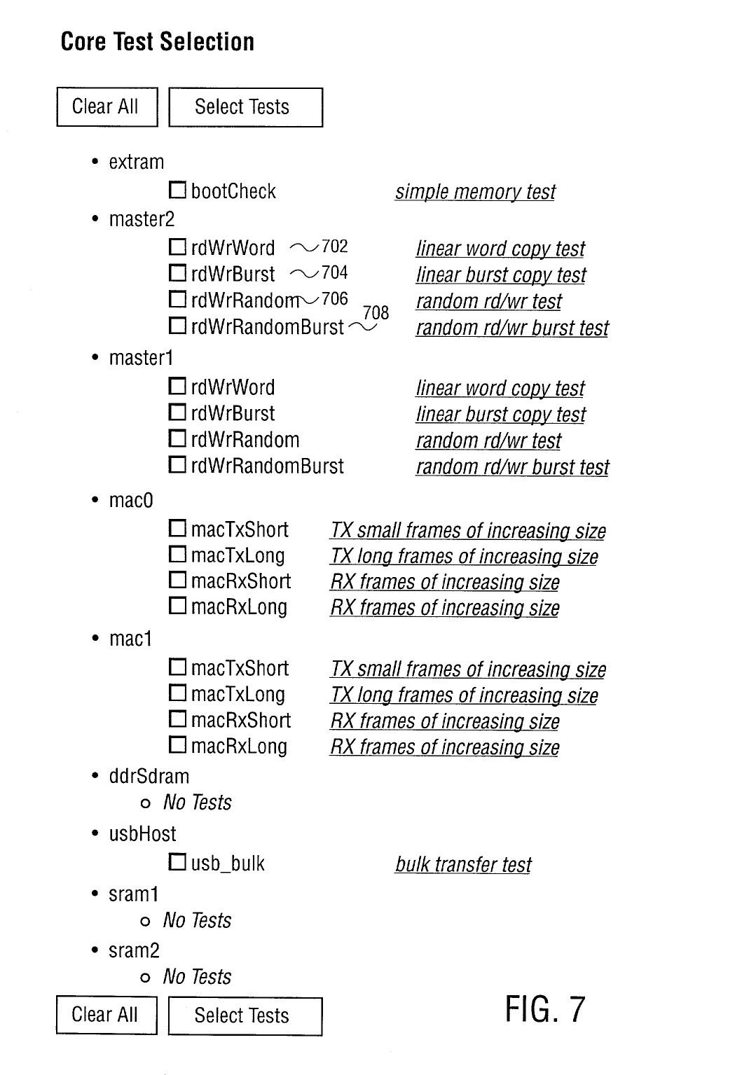

FIG. 7 illustrates an example display of tests that can be performed by a user for components of the model of interest, in this example, the model of FIG. 6. In one embodiment, the provider of the components of the IC model determines the tests that are available. Thus, for example, tests 702, 704, 706 and 708 are available to test the instantiated CPU core named “master 2”. In another embodiment, the user provides tests to be performed on the IC model. From this example, the user can easily select the tests to be run on this IC model using, for example, a cursor control device.

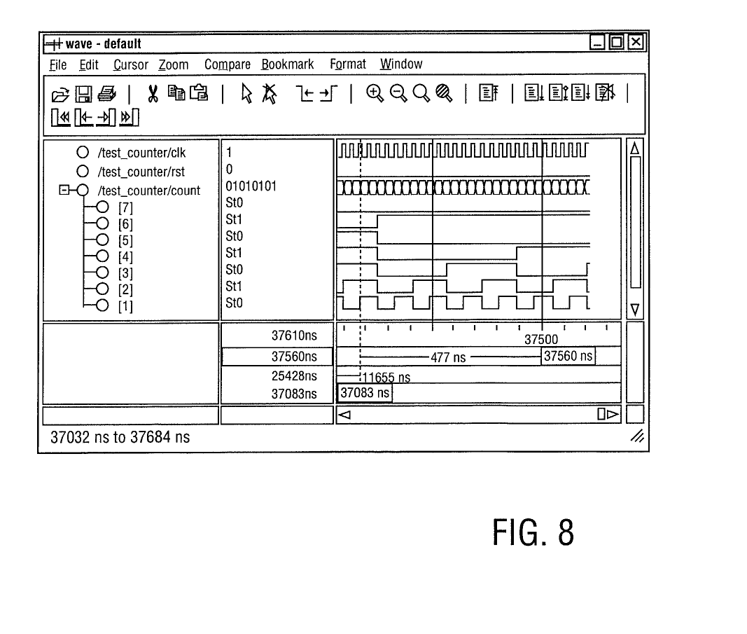

FIG. 8 is an example display of an output of tests performed on an IC model. FIG. 8 is one embodiment of many different embodiments of display formats and information provided in an output display. The output can take a variety of forms including a graphic display, a listing of signal values and waveforms in any combination. FIG. 8 illustrates a number of signal waveforms, which include, in one embodiment, input points, output points and test points (neither input or output but an intermediary point of interest) in the design.

The output display(s) can, in one embodiment, be manipulated to provide a variety of information on the behavior of an IC. For example, as illustrated in FIG. 8, a specific point in time in the test is highlighted across the displayed waveforms (e.g. 37,560 ns).

It will be appreciated that that more or fewer processes may be incorporated into the method(s) illustrated by FIGS. 1-8 without departing from the scope of the invention and that no particular order is implied by the arrangement of blocks (for example as shown in FIGS. 3 and 4) shown and described herein.

It further will be appreciated that the method(s) and structures described in conjunction with FIGS. 1-8 may be embodied in machine-executable instructions, e.g. software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The methods may be provided as a computer program product that may include a machine-readable medium having stored thereon instructions that may be used to program a computer (or other electronic devices) to perform the methods. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to included, but not be limited to, solid-state memories, optical and magnetic disks, and carrier wave signals. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or a produce a result.

In the foregoing specification, the invention is described with reference to specific embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A system comprising:
a computational subsystem configured to perform simulation of an IC model including at least one component, the testing requiring access to confidential information regarding the at least one component;
a user interaction subsystem configured to enable a user to run at least one simulation of the IC model; and
a secure interface coupled between the computational subsystem and the user interaction subsystem, said secure interface permitting the transfer of the user established IC model information and input test selection and/or configuration data to simulate at least part of the IC model and prohibiting user access to the confidential information, said secure interface further permitting the transfer of output simulation results to the user, wherein the user can specify an IC model and simulate at least part of the IC model without access to component confidential information.

2. The system as set forth in claim 1, wherein the confidential information is selected from the group consisting of a simulation model of a component of the IC, a simulation model of an IC, test code to simulate components and test code to simulate an IC model.

3. The system as set forth in claim 1, wherein the secure interface further permits the computational subsystem to identify to the user tests that can be performed, the tests to be performed and/or test parameters to be used being selectable by the user.

4. The system as set forth in claim 1, said user interaction subsystem further includes a user interface, the user capable of inputting information regarding test and/or parameter selection for running the simulation of at least one IC model through the user interface and further capable of receiving information regarding output simulation results through the user interface.

5. The system as set forth in claim 1, wherein the user accesses the user interaction subsystem through a connection selected from the group consisting of a network connection and a direct connection.

6. The system as set forth in claim 5, wherein the network connection is selected from the group consisting of a local area network and the Internet.

7. The system as set forth in claim 1, wherein the user may select from the group consisting of selection of an IC model from system-provided IC models, selection from system-provided components to form an IC model, modification of a selected system-provided IC model, generation of an IC model of user designed components, generation of an IC model of system-provided components and user designed components.

8. The system as set forth in claim 1, wherein the at least one simulation selection is dependent upon at least one of the IC models and at least one component.

9. The system as set forth in claim 1, wherein the input test selection and/or configuration data is selected from the group consisting of signal inputs and test code.

10. The system as set forth in claim 1, further including a testbench upon which the IC model is simulated.

11. A method comprising:
providing a computational subsystem configured to perform simulation of an IC model including at least one component, the testing requiring access to confidential information regarding the at least one component;
providing a user interaction subsystem configured to enable a user to run at least one simulation of the IC model; and
providing a secure interface coupled between the computational subsystem and the user interaction subsystem, said secure interface permitting the transfer of the user established IC model information and input test selection and/or configuration data to simulate at least part of the IC model and prohibiting user access to the confidential information, said secure interface further permitting the transfer of output simulation results to the user, wherein the user can specify an IC model and simulate at least part of the IC model without access to component confidential information.

12. The method as set forth in claim 11, wherein the confidential information is selected from the group consisting of a simulation model of a component of the IC, a simulation model of an IC, test code to simulate components and test code to simulate an IC model.

13. The method as set forth in claim 11, wherein the secure interface further permits the computational subsystem to identify to the user tests that can be performed, the tests to be performed and/or test parameters to be used being selectable by the user.

14. The method as set forth in claim 11, further permitting the user to input information regarding test and/or parameter selection for running the simulation of at least one IC model through a user interface and further receive information regarding output simulation results through the user interface.

15. The method as set forth in claim 11, wherein the user accesses the user interaction subsystem through a connection selected from the group consisting of a network connection and a direct connection.

16. The method as set forth in claim 15, wherein the network connection is selected from the group consisting of a local area network and the Internet.

17. The method as set forth in claim 11, wherein the user may select from the group consisting of selection of an IC model from system-provided IC models, selection from system-provided components to form an IC model, modification of a selected system-provided IC model, generation of an IC model of user designed components, generation of an IC model of system-provided components and user designed components.

18. The method as set forth in claim 11, wherein the at least one simulation selection is dependent upon at least one of the IC models and at least one component.

19. The method as set forth in claim 11, wherein the input test selection and/or configuration data is selected from the group consisting of signal inputs and test code.

20. The method as set forth in claim 11, further including providing a testbench upon which the IC model is simulated.
